(19) United States
(12) Patent Application Publication
(10) Pub. No.: US 2014/0208558 A1
(43) Pub. Date: Jul. 31, 2014

(54) RAMMER TOOL

(71) Applicant: PRODUCTION PRODUCTS, INC., Charlotte Hall, MD (US)

(72) Inventor: Chris Gass, Colton Point, MD (US)

(73) Assignee: PRODUCTION PRODUCTS, INC., Charlotte Hall, MD (US)

(21) Appl. No.: 13/751,519

(22) Filed: Jan. 28, 2013

(51) Int. Cl. B25B 27/14

(52) U.S. Cl. CPC B25B 27/14
USPC 29/283

(57) ABSTRACT

A rammer tool for installing hardware into pieces of conduit. The rammer tool includes a mounting section to mount the tool into an air hammer or other device. The rammer tool also includes a hardware section with a magnet to prevent hardware from falling off of the tool during the installation process.

### FIELD

The present disclosure relates to a rammer tool for installing hardware and, more particularly, to a rammer tool that includes one or more magnets to prevent the hardware from falling off the tool prior to installation.

### BACKGROUND

It is known to install pieces of conduit inside duct sections to brace the duct sections and prevent deformation due to changing air flow. It is necessary to install hardware inside the pieces of conduit to facilitate their installation. This hardware generally includes a retaining portion and a fastener portion. When installed, the retaining portion presses against the conduit creating an interference fit and holding the hardware in place. The fastener portion includes either a threaded shaft or a threaded hole which can interface with a complementary fastener installed on the outside of the duct.

One method of installing the hardware involves using an air hammer to insert the hardware into the conduit. This requires a tool or chuck to hold the hardware and transfer force from the air hammer to the hardware for installation. One drawback of existing tools is that they do not retain the hardware. This can result in the hardware falling off the tool during the installation process. In particular, the installation process often involves using the air hammer to drive hardware downward into upright pieces of conduit. Due to the orientation of the air hammer during this process it is common for the hardware to fall off the tool due to gravity when positioning the tool for installation. It would be beneficial to have a tool that securely retained the hardware such that it could not fall off when being positioned for installation.

### SUMMARY

The present disclosure provides a new rammer tool that includes magnets to retain the hardware during the installation process.

Two variations of the rammer tool are presented. One is configured to install hardware components with threaded holes (referred to as female fasteners) and the other is configure to install hardware with threaded shafts (referred to as male fasteners). Each variation includes at least one magnet to retain hardware during the installation process. The addition of the at least one magnet is an improvement over existing tools because they are placed to retain the hardware without significantly impacting the installation process. This makes installation easier and quicker by decreasing or even eliminating dropped hardware.

In one form, the present disclosure provides a rammer tool for installing hardware comprising a mounting section, a hardware section connected to the mounting section, and at least one magnet installed in the hardware section. The at least one magnet can be configured to prevent a piece of hardware from falling off of the rammer tool. The hardware section can include a first cylindrical portion having a first diameter and a second cylindrical portion having a second diameter. The first diameter can be smaller than the second diameter such that the first cylindrical portion protrudes from an end of the second cylindrical portion. The at least one magnet can be positioned on the end of the of the second cylindrical portion. The at least one magnet may include two magnets positioned on the end of the of the second cylindrical portion. The at least one magnet can also include a third magnet positioned on the end of the of the first cylindrical portion.

The rammer tool may further include a middle section positioned between the mounting section and the hardware section. The middle section can include a first cylindrical portion having a first diameter and a second cylindrical portion having a second diameter. The first cylindrical portion can be connected to the mounting section and the second cylindrical portion can be connected to the hardware section. The first diameter can be smaller than the second diameter.

The mounting section can include a cylindrical portion and a flared portion. The flared portion can be configured to engage a retaining device on an air tool.

In another form, the hardware section can include a cylindrical portion with a fastener receiving recess defined therein. The at least one magnet can be positioned in a magnet receiving recess defined in a wall of the fastener receiving recess. The fastener receiving recess can extend through the hardware section and into the second cylindrical portion of the middle section.

Further areas of applicability of the present disclosure will become apparent from the detailed description provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a perspective view of a rammer tool in accordance with the present disclosure.

FIG. 2 is a cross-sectional view of the rammer tool illustrated in FIG. 1.

FIG. 3 is a perspective view of a rammer tool in accordance with the present disclosure.

FIG. 4 is a cross-sectional view of the rammer tool illustrated in FIG. 3.

FIGS. 5A-C are perspective views of hardware in accordance with the present disclosure.

FIG. 6 is a side view of a rammer tool in accordance with the present disclosure installed on an air hammer.

### DETAILED DESCRIPTION

The present disclosure provides a rammer tool, which includes one or more magnets to retain hardware during the installation process. The magnets of the currently disclosed tool are positioned to prevent hardware from falling off of the tool due to gravity or movement of the tool when the tool and hardware are being positioned for installation.

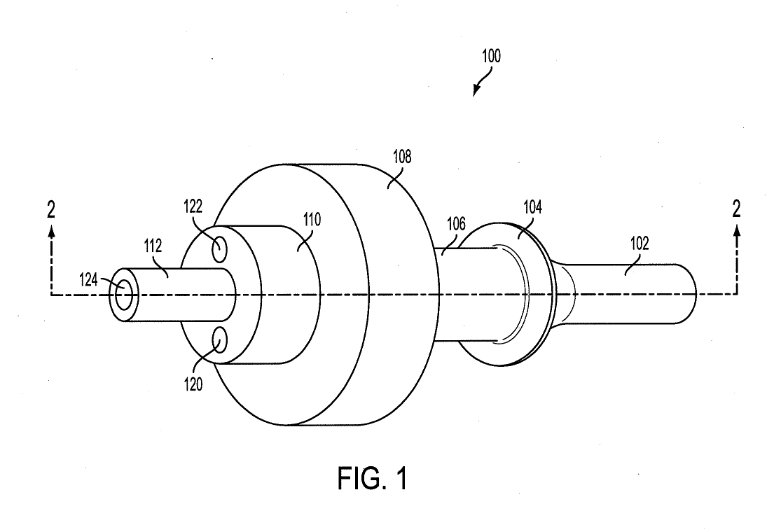

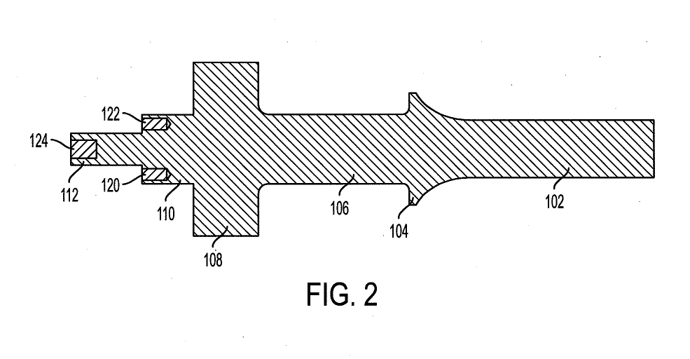

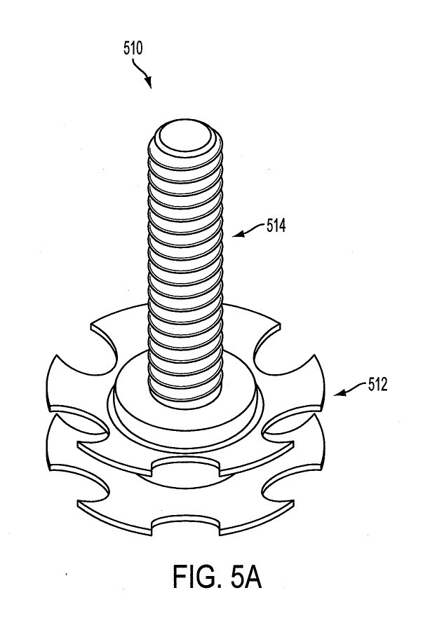

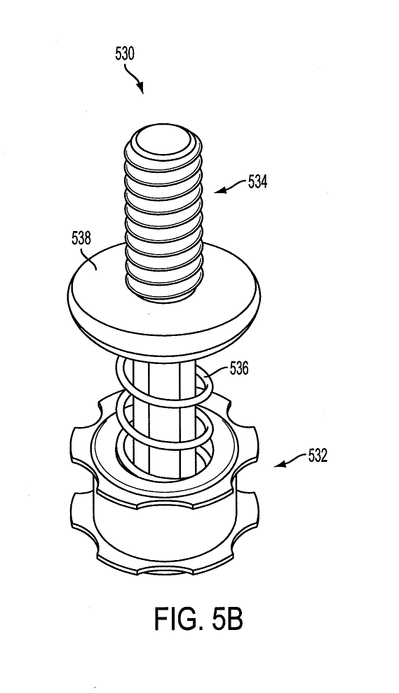

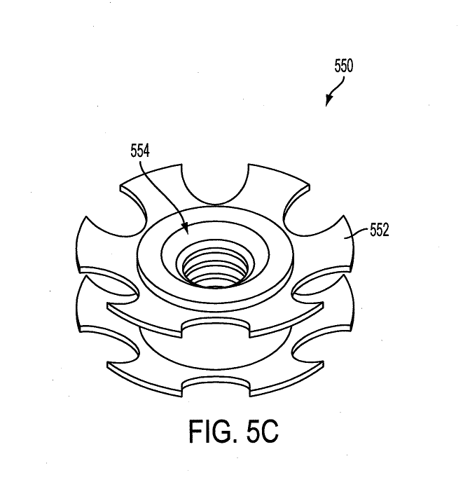

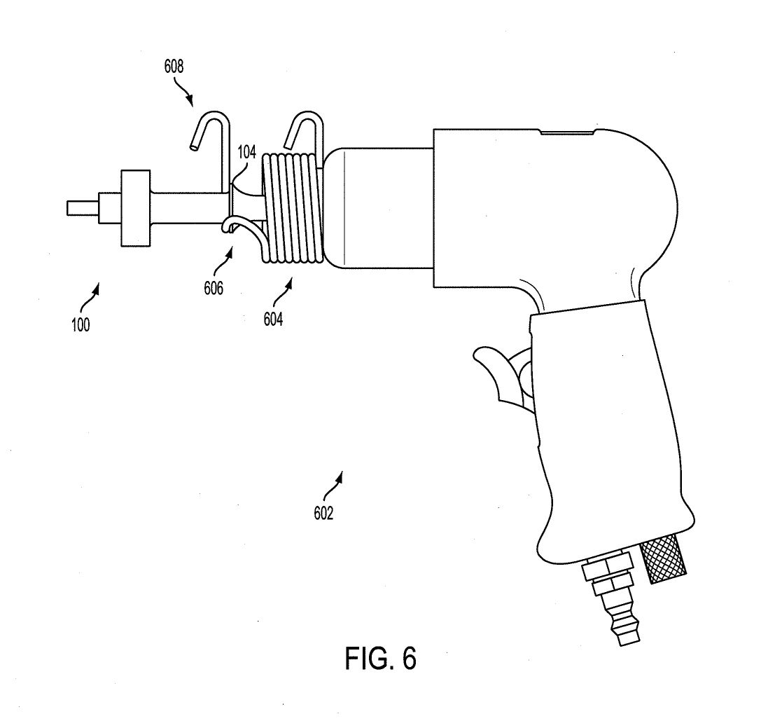

Referring now to the drawings, FIGS. 1 and 2 illustrate an embodiment of a male rammer tool 100 for installation of female hardware (550 in FIG. 5C) into pieces of conduit. The male rammer tool 100 includes a cylindrical portion 102 that is used in mounting the tool on an air hammer (as seen in FIG. 6 and discussed later) or other device. The tool 100 further includes a. flared portion 104 that is configured to engage a spring clutch (604 in FIG. 6) or other retention mechanisms. Cylindrical portion 102 and flared portion 104 make up a mounting section that serves primarily to mount the tool 100 on an air hammer or other device.

The tool 100 also includes a middle section made up of two cylindrical portions 106, 108. First cylindrical portion 106 is connected to the flared portion 104. Second cylindrical portion 108 is connected to the first cylindrical portion 106 on one side and to a hardware section (discussed below) on the other side. Second cylindrical portion 108 can have a larger diameter than the first cylindrical portion 106. The middle section provides the required length and also supplies additional weight, which is necessary to generate the required force for installing the hardware into the conduit. Second cylindrical portion 108 may also act as a stop to ensure hardware is installed to the correct depth inside the piece of conduit.

Tool 100 further includes the hardware section made up of two additional cylindrical portions 110 and 112. The first cylindrical section 112 of the hardware portion extends from and has a smaller diameter than the second cylindrical section 110 of the hardware portion. The first cylindrical section 112 is sized to accommodate the threaded hole 554 of a female fastener 550 (see FIG. 5C). The tool 100 includes three magnets 120, 122, and 124. Magnets 120 and 122 are positioned in the end of the second cylindrical section 110 of the hardware portion. Magnet 124 is positioned in the end of the first cylindrical section 112. When a female fastener 550 is installed on tool 100 the magnets 120, 122, 124 provide an attractive force to retain the female fastener and prevent it from falling off the tool 100. This aids in installation by decreasing or eliminating the possibility that the female fastener 550 will fall off of the tool 100 prior to installation in the conduit.

FIG. 2 is a cross-sectional view of the FIG. 1 tool 100 taken along line 2-2 in FIG. 1. The relative size and diameters of the various portions of the tool 100 are apparent in FIG. 2. FIG. 2 also indicates the placement and size of the magnets 120, 122, 124. The relative sizes can be changed and the middle section can be made of a single portion rather than two distinct portion as shown.

FIG. 6 shows the tool 100 mounted on an air hammer 602. Air hammer 602 includes a spring clutch 604. Spring clutch 604 is made up of spring coils with a specially formed last coil 606 that engages flared portion 104. The rammer tool 100 is free to move back and forth in the air hammer 602, but the coil 606 engages the flared portion 104 preventing the tool 100 from falling out of the air hammer 602. A release coil 608 is also formed on the spring chuck 604. By applying force to the release coil 608, a user can deflect the coil 606 sufficiently to disengage the flared portion 104. This allows the user to mount and dismount the tool 100 on the air hammer 602.

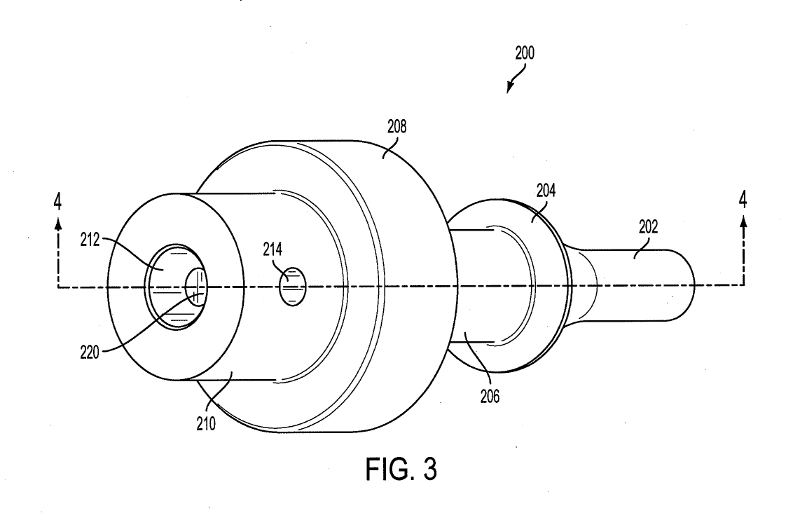

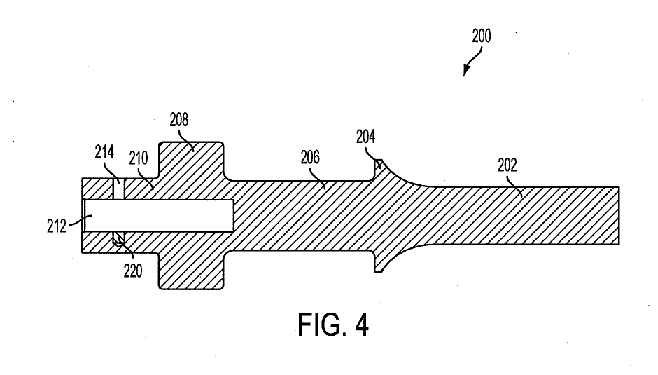

FIGS. 3 and 4 illustrate an embodiment of a female rammer tool 200 for installation of male hardware (510 and 530 in FIGS. 5A and 5B, respectively) into pieces of conduit. Similar to the male rammer tool 100, the female rammer tool 200 includes a cylindrical portion 202 and a flared portion 204 that are used in mounting the tool on an air hammer or other device.

Also similar to the male rammer tool 100, the female rammer tool 200 includes a middle section made up of two cylindrical portions 206 and 208. First cylindrical portion 206 is connected to the flared portion 204. Second cylindrical portion 208 is connected to the cylindrical portion 206 on one side and to a hardware section (discussed below) on the other side. Second cylindrical portion 208 can have a larger diameter than the first cylindrical portion 206. As discussed above, the middle section provides the required length and also supplies additional weight, which is necessary to generate the required force for installing the hardware into the conduit.

The female tool 200 also includes the hardware section, which comprises a cylindrical section 210 with a fastener receiving recess 212 defined therein. The fastener receiving recess 212 is a blind hole that is cylindrical in shape and is configured to accommodate the threaded shaft 514, 534 of male hardware or fasteners 510, 530. A magnet 220 is mounted in a magnet receiving recess formed in the wall of the fastener receiving recess 212. The magnet receiving recess is formed by cross drilling a hole 214 through the one side cylindrical portion 210. This is best seen in reference to FIG. 4, which is a cross-sectional view of the female rammer tool 200 of FIG. 3 taken along line 4-4. FIG. 4 illustrates that the fastener receiving recess 212 may extend into or through the cylindrical sections 208, 206 of the middle section to accommodate hardware and fasteners of varying lengths. FIG. 4 also illustrates how, by cross drilling the hole 214, a blind hole, also known as the magnet receiving recess, can be formed in the inner wall of the fastener receiving recess 212. Hole 214 can have a larger diameter than the magnet receiving recess (i.e., drilled with a larger bit). Thus the magnet 220 can be positioned adjacent the magnet receiving recess and press fit into place through hole 214. Magnet 220 is positioned to provide an attractive force on the threaded shaft 514, 534 of male hardware or fasteners 510, 530 to retain the male fasteners and prevent them from falling off the tool 200. As discussed above, this ensures that the fasteners do not fall off the tool, enabling easier and more efficient installation.

FIGS. 5A-5C illustrate different types of hardware or fasteners that can be installed using the currently disclosed tools 100, 200. FIG. 5A shows a male fastener 510 that includes a threaded shaft 514 and a conduit engaging ring 512. When installed, the male fastener 510 is press fit into a piece of conduit such that the conduit engaging ring 512 holds the fastener 510 in place. When the conduit containing the fastener 510 is installed as a brace in a duct section, the threaded shaft 514 will extend through a hole in the duct section and a complementary female fastener can be installed to secure the conduit.

FIG. 5B illustrates a second form of male fastener or hardware 530. This fastener includes a threaded shaft 534 and a conduit engaging ring 532. Fastener 530 further includes a spring 536 and a plate 538. Fastener 530 is configured such that the central shaft portion on which the threaded shaft 534 is formed can move relative to the bottom portion on which the conduit engaging ring 532 is formed. This allows for some level of compliance or movement while still securing the conduit inside the duct sections. As discussed above, the conduit engaging ring 532 is press fit into a piece of conduit and the threaded shaft 534 protrudes through the side of the duct section to received a complementary female fastener to secure the conduit.

FIG. 5C illustrates a female fastener 550. Female fastener 550 includes a threaded center section 554 and a conduit engaging ring 552. When installed in a piece of conduit, a threaded shaft portion of a complementary male fastener can be threaded into the threaded center section 554 to secure the conduit in the duct section.

While particular embodiments have been shown it should be recognized that any number of configurations are envisioned. By way of example only, the middle section can be formed as a single section. Additionally, many cylindrical portions are shown, but these could also be formed as other shapes. Additional magnets could be used if beneficial to retain fasteners of a given size or type. These and any other variations are considered to be within the scope of this disclosure.

What is claimed is:

1. A rammer tool for installing hardware comprising:
a mounting section,
a hardware section connected to the mounting section, and
at least one magnet installed in the hardware section.

2. The rammer tool of claim 1, wherein the hardware section includes a first cylindrical portion having a first diameter connected to a second cylindrical portion having a second diameter.

3. The rammer tool of claim 2, wherein the first diameter is smaller than the second diameter such that the first cylindrical portion protrudes from an end of the second cylindrical portion.

4. The rammer tool of claim 2, wherein the at least one magnet is positioned on the end of the of the second cylindrical portion.

5. The rammer tool of claim 2, wherein the at least one magnet includes two magnets positioned on the end of the of the second cylindrical portion.

6. The rammer tool of claim 5, further comprising a third magnet positioned on the end of the of the first cylindrical portion.

7. The rammer tool of claim 3, wherein the at least one magnet is positioned on the end of the of the first cylindrical portion.

8. The rammer tool of claim 1, further comprising a middle section positioned between the mounting section and the hardware section.

9. The rammer tool of claim 8, wherein the middle section includes a first cylindrical portion having a first diameter and a second cylindrical portion having a second diameter.

10. The rammer tool of claim 9, wherein the first cylindrical portion is connected to the mounting section and the second cylindrical portion is connected to the hardware section, and the first diameter is smaller than the second diameter.

11. The rammer tool of claim 1, wherein the mounting section includes a cylindrical portion and a flared portion.

12. The rammer tool of claim 11, wherein the flared portion is configured to engage a retaining device on an air tool.

13. The rammer tool of claim 1, wherein the hardware section includes a cylindrical portion with a fastener receiving recess defined therein.

14. The rammer tool of claim 13, wherein the at least one magnet is positioned in a magnet receiving recess defined in a wall of the fastener receiving recess.

15. The rammer tool of claim 13, further comprising a middle section positioned between the mounting section and the hardware section.

16. The rammer tool of claim 15, wherein the middle section includes a first cylindrical portion having a first diameter and a second cylindrical portion having a second diameter.

17. The rammer tool of claim 16, wherein first cylindrical portion is connected to the mounting section and the second cylindrical portion is connected to the hardware section, and the first diameter is smaller than the second diameter.

18. The rammer tool of claim 15, wherein the fastener receiving recess extends through the hardware section and into the second cylindrical portion of the middle section.

19. The rammer tool of claim 1, wherein the at least one magnet is configured to prevent a piece of hardware from falling off of the rammer tool.

20. A rammer tool for installing hardware comprising:
means for mounting the tool on air hammer,
means for holding a fastener on the tool, and
magnetic means for retaining the fastener on the tool.
